(19) United States
(12) Patent Application Publication
(10) Pub. No.: US 2006/0064393 A1
(43) Pub. Date: Mar. 23, 2006

(54) Computer-based systems and methods for generating vehicle repair estimates and repair estimates prepared therewith

(76) Inventor: Stuart J. Orr, Port Charlotte, FL (US)

Correspondence Address: Donald R. Palladino;PPG INDUSTRIES, INC., One PPG Place, Pittsburgh, PA, 15272, US

(21) Appl. No.: 10/946,921

(22) Filed: Sep. 22, 2004

(51) Int. Cl. G06F 17/00

(52) U.S. Cl. 705/400

(57) ABSTRACT

Disclosed are computer-based systems for generating vehicle repair estimates, such as repair estimates for commercial trucks. Also disclosed are computer-based methods for generating a vehicle repair estimate and vehicle repair estimate reports prepared using such systems and/or methods.

### FIELD OF THE INVENTION

The present invention relates to computer-based systems for generating vehicle repair estimates, such as repair estimates for commercial trucks. The present invention is also directed to computer-based methods for generating a vehicle repair estimate. In addition, the present invention is directed to vehicle repair estimates, such as commercial truck repair estimates, prepared with the systems and methods of the present invention.

### BACKGROUND OF THE INVENTION

Generating estimates for vehicle repairs has historically been a time-consuming, yet inconsistent and imprecise process. Hand written estimates based upon guesswork or the individual experience of the estimator have been common. Such hand written estimates are often undesirable from the standpoint of insurance companies, vehicle owners and/or repair shops, all of which rely on estimate accuracy. These estimates may also be undesirable, because they can be time-consuming to generate.

As a result, attempts have been made to make estimate generation more consistent and less time-consuming. In the passenger car market, for example, computer-based estimating systems have been developed based on logic driven programs wherein a user enters information regarding vehicle damage, and the system determines what repairs need to be made, including repairs and replacement of associated parts or materials, and the cost associated for the repairs.

In the commercial truck market, however, computer-based estimating systems are less common, at least partly due to the level to which commercial trucks are custom built. One commercial truck estimating system, offered by Mitchell International, Inc. and known as TruckEst®, is an electronic version of a repair manual designed to give an estimator an idea of repair parts and labor time that can be generated with a particular repair. The TruckEst® system is not a logic-based system that assists in preparing a repair estimate, i.e., it does not include any logic that captures non-included items, proper repair sequencing, and/or logic for associated operations.

Another computer-based estimating system that has been available to the commercial truck repair market is known as the Adjustrite™ heavy truck estimating system. This system, which has been provided in a DOS program format, contains programmed logic based on historical repair estimate data. This logic captures non-included items, proper repair sequencing, and required associated operations for a particular repair. The Adjustrite system produces estimates that capture many hidden or unforeseen cost areas that may be overlooked during handwritten estimates.

One problem, however, that has been associated with the Adjustrite™ system is that parts and logic information cannot be readily updated or changed. As a result, as new parts become available or employed in new vehicle models, or new vehicle models are introduced, this part and model information cannot be added to the system, or the logic employed by the system, except through reprogramming by a qualified computer programmer with a relatively high level of programming knowledge. As a result, the Adjustrite™ system has had certain limitations, such as in its ability to provide logic driven repair estimates for commercial trucks, particularly those involving newer truck models and parts.

Therefore, it would be advantageous to provide improved computer-based repair estimating systems, adaptable for preparing repair estimates for commercial trucks, which are constructed so that, among other things, a user who lacks a high level of computer programming knowledge, can modify a database of vehicle models, parts, and repair logic.

### SUMMARY OF THE INVENTION

In certain respects, the present invention is directed to computer-based vehicle repair estimating systems. These systems of the present invention comprise: (a) at least one database comprising at least one of vehicle make data, vehicle model data, vehicle part subgroup data, or vehicle part data; (b) at least one vehicle repair estimate generating module in communication with the database, wherein an estimate-generating user can create a vehicle repair estimate; and (c) at least one database modification module in communication with the database, wherein a database maintenance user can modify the database.

In other respects, the present invention is directed to computer-based commercial truck repair estimating systems. These systems of the present invention comprise: (a) at least one database comprising at least one of commercial truck make data, commercial truck model data, commercial truck part subgroup data, or commercial truck part data; (b) at least one commercial truck repair estimate generating module in communication with the database, wherein an estimate-generating user can create a commercial truck repair estimate; and (c) at least one database modification module in communication with the database, wherein a database maintenance user can modify the database.

In still other respects, the present invention is directed to computer-based methods for generating commercial truck repair estimates. These methods of the present invention comprise the steps of: (a) receiving truck damage information from an estimate-generating user via a damage information input interface; (b) retrieving repair data from a database comprising at least one of commercial truck make data, commercial truck model data, commercial truck part subgroup data, and commercial truck part data; (c) illustrating selected repair data in an output interface; and (d) generating a truck repair estimate report based on the selected repair data.

In yet other respects, the present invention is directed to vehicle repair estimates, such as commercial truck repair estimates, prepared with the foregoing systems and methods of the present invention.

### BRIEF DESCRIPTION OF THE DRAWINGS

FIG. 1 is a block diagram illustrating the basic arrangement of components of a computer-based vehicle repair estimating system in accordance with certain embodiments of the present invention;

FIG. 2 is an example of a computer screen depicting a login interface that may be included within certain embodiments of the present invention;

FIG. 3 is an example of a computer screen depicting a home screen that may be included within certain embodiments of the present invention;

FIG. 4 is an example of a computer screen depicting a profile maintenance interface that may be included within certain embodiments of the present invention;

FIG. 5 is an example of a computer screen depicting a customer submodule interface that may be included within certain embodiments of the present invention;

FIG. 6 is an example of a computer screen depicting a unit submodule interface that may be included within certain embodiments of the present invention;

FIG. 7 is an example of a computer screen depicting a rate override submodule interface that may be included within certain embodiments of the present invention;

FIGS. 8 to 11 are examples of computer screens depicting an estimate submodule interface that may be included within certain embodiments of the present invention;

FIG. 12 is an example of a computer screen depicting an estimate summary submodule interface that may be included within certain embodiments of the present invention;

FIG. 13 is an example of a repair estimate report that may be produced by certain embodiments of the present invention; and

FIGS. 14 to 23 are examples of computer screens depicting a maintenance interface that may be included within certain embodiments of the present invention.

### DESCRIPTION OF EMBODIMENTS OF THE INVENTION

For purposes of the following detailed description, it is to be understood that the invention may assume various alternative variations and step sequences, except where expressly specified to the contrary. It is also to be understood that the specific devices and processes described in the following specification are simply exemplary embodiments of the invention. Hence, any specific dimensions or other physical characteristics related to the embodiments disclosed herein are not to be considered as limiting.

The following description is directed to computer-based vehicle repair estimating systems, such as commercial truck repair estimating systems, and computer-based methods for generating vehicle repair estimates, such as methods for generating commercial truck repair estimates. As will be appreciated by the skilled artisan, one or more computer programs would typically be written to create such systems and methods. Therefore, the following description is written to enable a computer programmer having ordinary skill in the art to prepare an appropriate program for one or more computers to carry out the systems and methods of the present invention. The present invention is not limited to any of the particular details of such programs, which would depend upon many factors, such as the architecture of the particular computer selected.

The computer-based systems and methods of the present invention are directed to the preparation of damage repair estimates for vehicles, such as commercial trucks. As used herein, the term “computer-based” refers to systems that at least partially reside on at least one computer and methods that are at least partially carried out on at least one computer. In certain embodiments, the systems of the present invention reside entirely on at least one computer and, in other embodiments, all of the steps of the methods of the present invention are carried out on at least one computer.

In certain embodiments, the present invention is directed to computer-based vehicle repair estimating systems, such as commercial truck repair estimating systems, which comprise (a) at least one database comprising at least one of vehicle make data, vehicle model data, vehicle part subgroup data, or vehicle part data; (b) at least one vehicle repair estimate generating module in communication with the database, wherein an estimate-generating user can create a vehicle repair estimate; and (c) at least one database modification module in communication with the database, wherein a database maintenance user can modify the database.

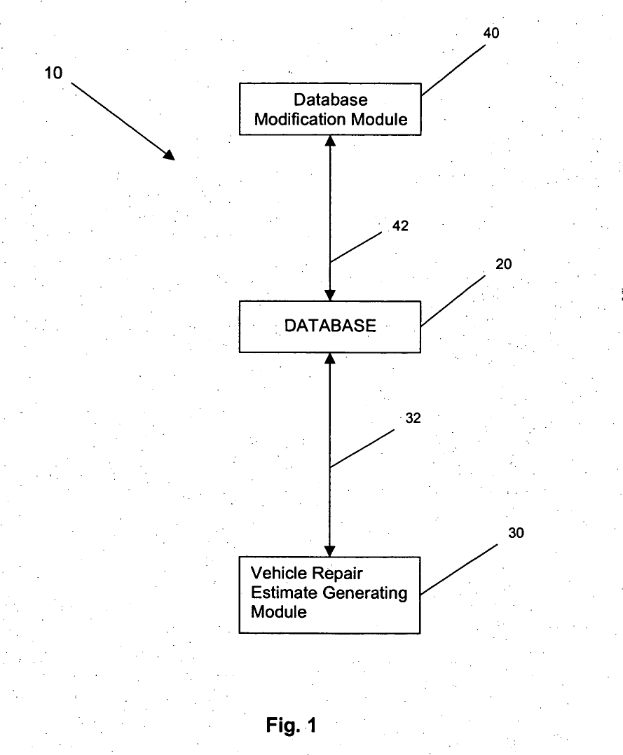

Referring now to FIG. 1, there is depicted a block diagram illustrating the basic arrangement of components of a computer-based system in accordance with certain embodiments of the present invention. As is apparent, system 10 comprises a database 20 that is in communication with a vehicle repair estimate generating module 30 and a database modification module 40. It will be appreciated by those skilled in the art that, in certain embodiments, each of the database 20, the vehicle repair estimate generating module 30, and the database modification module 40, may reside on a single computer or, in other embodiments, one or more of these components may reside elsewhere, such as one or more other computers. The particular location of the database 20, the vehicle repair estimate generating module 30 and a database modification module 40 is not critical to the systems of the present invention. For example, in certain embodiments of the present invention, each of the database 20, the vehicle repair estimate generating module 30, and the database modification module 40 reside on a separate computer, each of which may be located at a different geographical location. The operating system for such computer(s) is also not critical and may include Windows, Macintosh, or Unix operating systems, among others.

In the systems of the present invention, the database 20 is in communication with the vehicle repair estimate generating module 30 and the database modification module 40. In the embodiment illustrated in FIG. 1, database 20 is in communication with the vehicle repair estimate generating module 30 and the database modification module 40 via communication media 32 and 42, respectively. While the particulars of communication media 32 and 42 are not limiting in the present invention, in certain embodiments of the invention these communication media may include, for example, one or more types of computer networks, such as, for example, local area networks (“LANs”), wide area networks (“WANs”), public Internets, private Internets, a private computer network, a secure Internet, a private network, a public network, a value-added network, interactive television networks, wireless data transmission networks, two-way cable networks, interactive kiosk networks, digital subscriber lines, cable modem lines, among other communication media.

As will be understood by those skilled in the art, the Internet is a global network of interconnected computers capable of sending and receiving information between and among one another. The structure of the Internet, which is well known, includes a network backbone comprising communications channels such as copper wire, optical fiber, or satellite based interconnections between numerous computers, hubs, and routers which control, direct, and maintain information passed between computers. Additional networks branch from the above-mentioned backbone, and these branches, in turn, have sub-networks branching from them, and so on. Typically, information is passed through the network in the form of packets, which are discrete pieces of information desirably sent through the network. These packets of information are encoded in a form interpretable by the network infrastructure and may support features such as data compression, encryption, and error correction to optimize the speed and efficiency by which the information is transferred. For a more detailed description of the structure and operation of the Internet, see “The Internet Complete Reference,” by Harley Hahn and Rick Stout, published by McGraw-Hill, 1994.

As noted earlier, the computer-based systems of the present invention comprise at least one database that comprises at least one of vehicle make data, vehicle model data, vehicle part subgroup data, or vehicle part data. As used herein, the term “database” refers to a collection of data, which may be arranged for ease and speed of search and retrieval. The data included within the database included within the systems of the present invention may come from any source. In addition, the type of database in which the aforementioned vehicle related data is stored is not critical to the systems of the present invention. Examples of the types of databases that may be used in the present invention include, without limitation, Microsoft Access databases, Oracle databases, SQL Server databases,.and Microsoft Excel spreadsheets, among others. The procedure for creating such a database would be readily apparent to one of ordinary skill in the art and thus will not be described here.

As indicated, the database included within the present invention comprises at least one of vehicle make data, vehicle model data, vehicle part subgroup data, or vehicle part data. As used herein, “vehicle make data” refers to any factual information relating to the make of a vehicle, such as, for example, a make name, a description of the make, and an active status indicator. As used herein, the term “vehicle model data” refers to any factual information relating to a vehicle model, such as, for example, a model name, a related vehicle make, a description of the model, and an active status indicator. As used herein, the term “vehicle part subgroup data” refers to any factual information relating to a vehicle part subgroup, such as, for example, a subgroup name, a diagram, a related major assembly, a paint overhaul time, a body overhaul time, a description, a related vehicle make, and a related vehicle model. As used herein, the term “vehicle part data” refers to any factual information relating to a vehicle part, such as, for example, a part name, a part number, a description of the part, a price, a region, an indication as to whether the part should be included in calculating paint overhaul time, an indication as to whether the part should be included in calculating labor overhaul time, an indication as to whether the part should be included when selecting an entire assembly, labor times, included parts, add-on labors, adjacent parts, and add-on parts.

Certain embodiments of the present invention are directed to vehicle, such as commercial truck, repair estimating systems. As used herein, the term “repair estimate”, and like terms, refer to a statement, such as a written or printed statement, indicating the approximate cost to do a repair job, such as repairing damage to a vehicle. As used herein, the term “vehicle” refers to any mechanized article used to carry or transport something, such as passenger cars, trucks, vans, buses, airplanes, and boats, among other things. As used herein, the term “commercial truck” refers to vehicles within vehicle classifications 3 to 8, including motor homes, and off-road vehicles. Non-limiting examples of commercial trucks include pickups, panels, vans, campers, ambulances, carryalls, buses, camping and recreation vehicles, auto transporters, and trailers (i.e., tractor trailers). In certain embodiments, the present invention is directed to repair estimating systems for “heavy trucks”, which term is used herein to refer to vehicles within vehicle classifications 7 and 8. As will be understood by those skilled in the art, vehicles are often classified on the basis of weight. For example, the vehicle classifications referred to herein are based on the weight ranges set forth in Table 1, below.

TABLE 1

| Classification | Weight | | Examples |
|---|---|---|---|
| Classes 1 and 2 | <10,000 | lbs. | Compact Vans, Pick Ups |
| Class 3 | 10,001 to 14,000 | lbs. | Shuttle Home Van, Walk-in |
| | | | Van |
| Class 4 | 14,001 to 16,000 | lbs. | Large Walk-Ins, Light |
| | | | Stake Trucks |
| Class 5 | 16,001 to 19,500 | lbs. | Bottle Gas/Fuel Delivery |
| | | | Trucks, Bucket Utility |
| | | | Vehicles |
| Class 6 | 19,501 to 26,000 | lbs. | Tow Trucks, Cab over |
| | | | Stake Trucks |
| Class 7 | 26,001 to 33,000 | lbs. | Refuse Trucks, Mass Transit |
| | | | Vehicles, Fire Trucks, Single |
| | | | Axle Fuel Trucks |
| Class 8 | >33,000 | lbs. | Medium Tandem |
| | | | Conventional Trailers, |
| | | | Cement Trucks, Heavy Duty |
| | | | Dump Trucks, Duel |
| | | | Axle Fuel Trucks |

The computer-based systems of the present invention include at least one vehicle repair estimate generating module. As used herein, the term “estimate generating module” refers to a section or component part of the computer-based estimating system wherein a repair estimate may be generated by, for example, an estimate-generating user. As used herein, the term “estimate-generating user” refers to an individual or group of individuals who are qualified to prepare damage repair estimates for vehicles, such as commercial trucks, but who do not necessarily possess any computer programming knowledge.

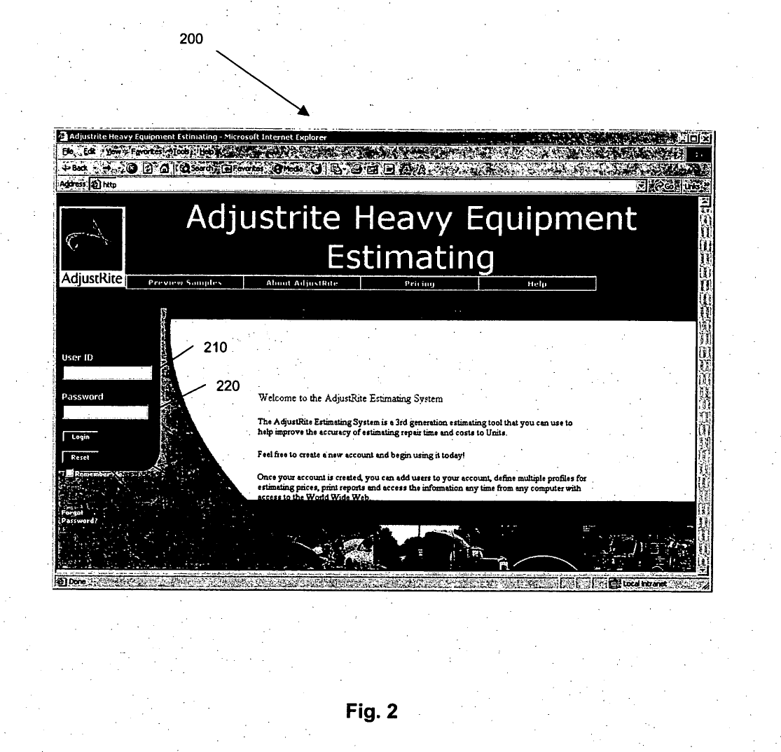

Certain non-limiting embodiments of the vehicle repair estimate generating module of the computer-based systems of the present invention winnow be described with reference to the drawings, beginning with FIG. 2. As is apparent, in certain embodiments, the vehicle repair estimate generating module may include a login interface. As used herein, the term “login interface” refers to a segment of the computer-based system wherein an estimate-generating user may communicate with and enter the vehicle repair estimate generating module. In the exemplary, but non-limiting login interface depicted in FIG. 2, an interface 200 is provided wherein an estimate-generating user may enter an identification number at User ID field 210 and a password at Password field 220. The estimate-generating user may then select the Login button 230 to enter the repair estimate generating module of the computer-based estimating system. Alternatively, the estimate-generating user may select Reset button 240 to reset the user's identification number and/or password.

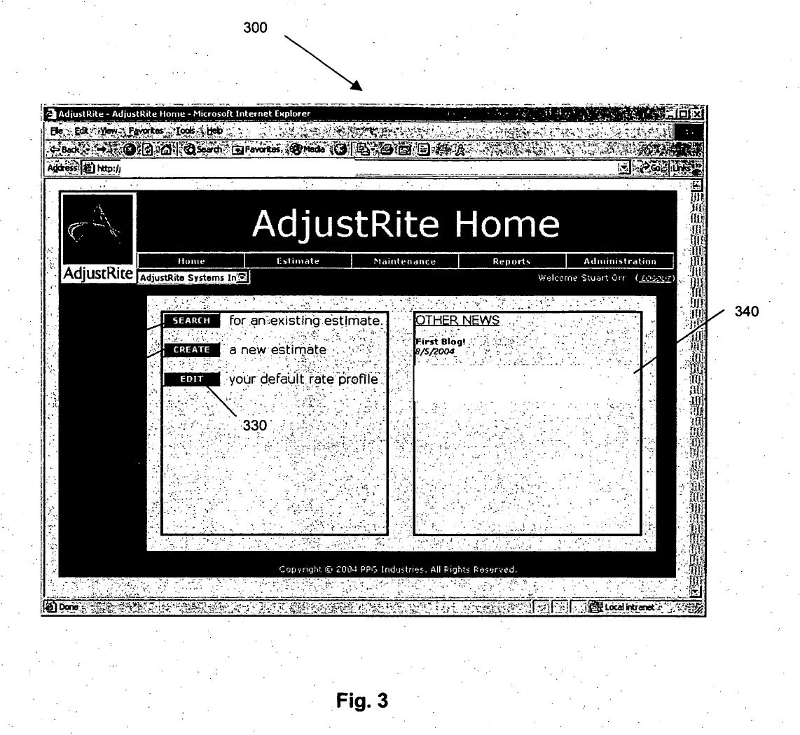

In certain embodiments of the systems of the present invention, the estimate-generating user is directed to a home interface after selecting the Login button 230 from the login interface of FIG. 2. An exemplary, but non-limiting, home interface 300 is depicted in FIG. 3, wherein an estimate-generating user may (i) search for an existing repair estimate by selecting the Search button 310, (ii) create a new estimate by selecting the Create button 320, or (iii) edit a default rate profile by selecting the Edit button 330. In addition, field 340 may be provided which may include additional useful information for an estimate-generating user.

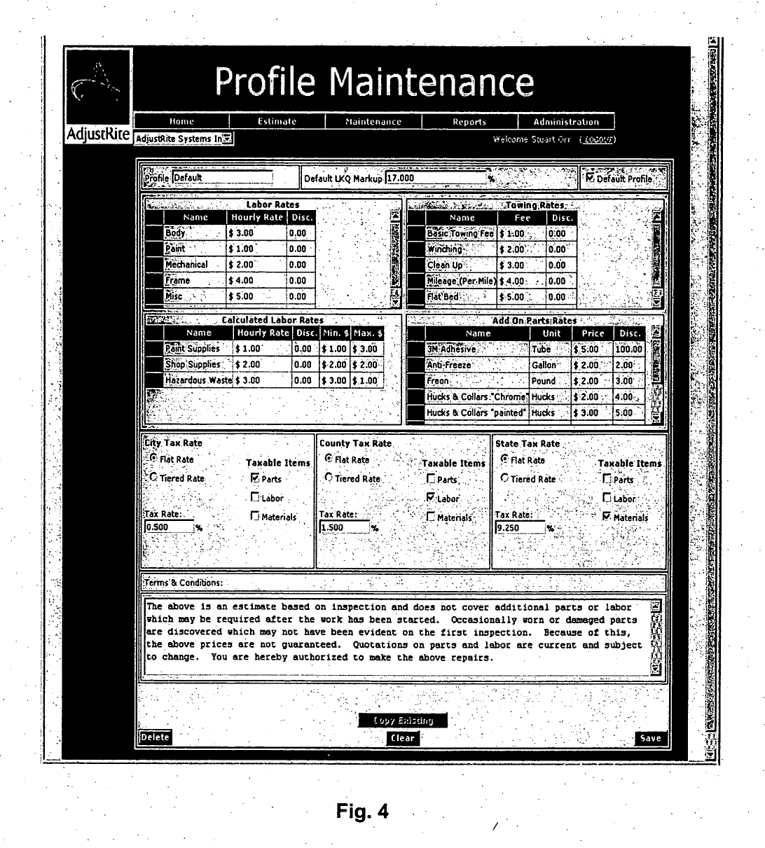

In the embodiment illustrated by FIG. 3, should a user select the Edit button 330, the user would be directed to a profile maintenance screen of the type illustrated in FIG. 4. Thus, in certain embodiments of the present invention, the vehicle repair estimate generating module also comprises a profile maintenance interface. As used herein, the term “profile maintenance interface” refers to a segment of the computer-based system wherein a user may communicate with the repair estimate generating module to modify data of relevance to a repair facility, such as labor rates, towing rates, add-on parts rates, and tax rates, among other things.

Referring once again to FIG. 3, should the user select the Create button 320, the user would, in certain embodiments of the present invention, be directed to a first submodule interface of the vehicle repair estimate generating module of the systems of the present invention. In certain embodiments of the present invention, the vehicle repair estimate generating module may comprise one or more submodule interfaces, such as a customer submodule interface, a unit submodule interface, a rate override submodule interface, an estimate submodule interface, and/or a summary submodule interface, among others. In the embodiments of the present invention illustrated by the Figures, the estimate-generating user is directed to the customer submodule interface of the estimate generating module upon selecting the Create button 320 in FIG. 3.

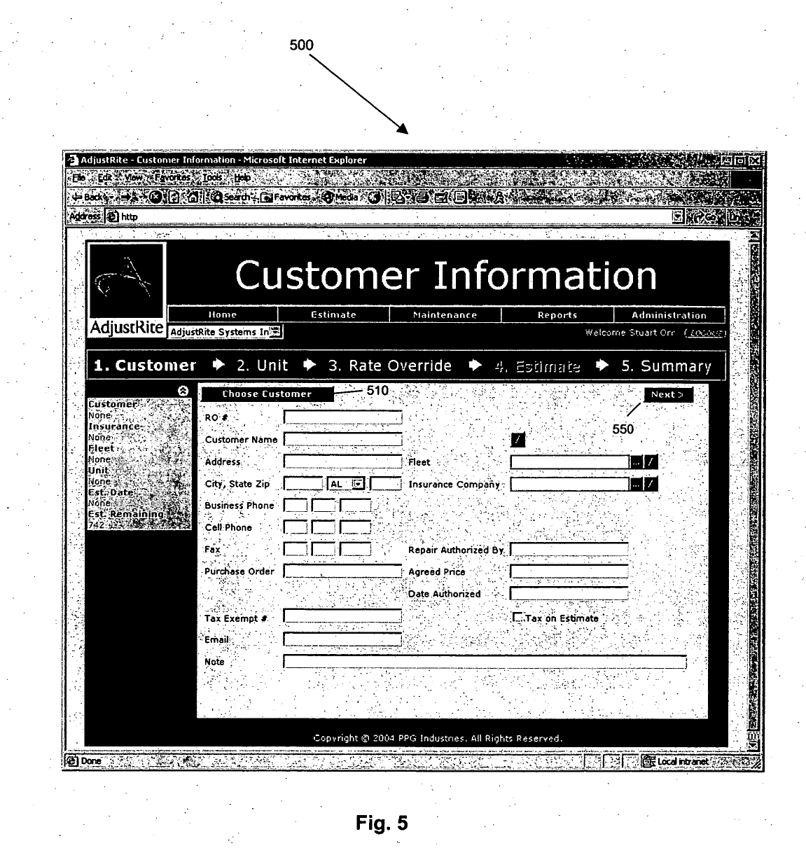

Now referring to FIG. 5, there is depicted a customer submodule interface 500 which may comprise an aspect of the vehicle repair estimate generating module, in accordance with certain embodiments of the present invention. As used herein, the term “customer submodule interface” refers to a section or component part of the computer-based system wherein an estimate-generating user may communicate with the estimate generating module to provide and/or retrieve information relating to a customer for whom a repair estimate may be prepared. As is apparent, in certain embodiments, an estimate-generating user may, if desired, select the Choose Customer button 510. If this button is chosen, the user may select an existing customer from a customer database stored within the vehicle repair estimate generating module, in which customer data is stored. Alternatively, in certain embodiments, an estimate-generating user may enter such customer data directly onto customer submodule interface 500. In particular, in certain embodiments, the estimate-generating user may enter one or more of the following: (i) Repair Order Number (“RO#”), (ii) Customer Name, (iii) Customer Address, (iv) Customer Business Phone, (v) Customer Cell Phone Number, (vi) Customer Fax Number, (vii) Purchase Order Number, (viii) Tax Exempt Number, (ix) E-mail Address, (x) Fleet Company Name, (xii) Insurance Company Name, (xiii) Repair Authorization person, (xiv) Agreed Price, (xv) Authorization Date, and (xvi) Notes. In certain embodiments, once the desired customer information is displayed on customer submodule interface 500, the estimate-generating user may select the Next button 550.

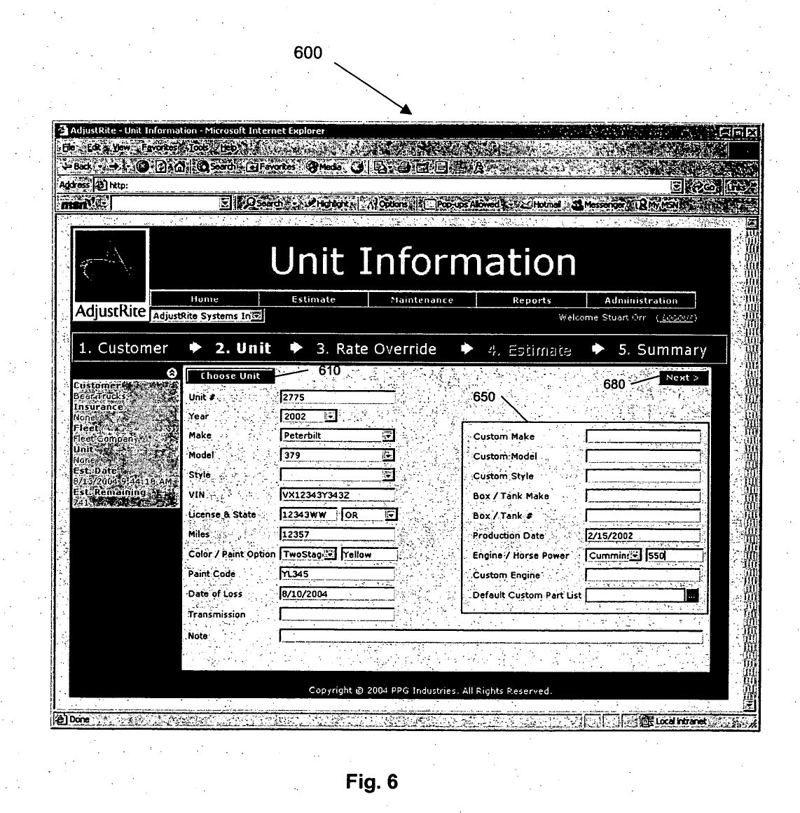

Now referring to FIG. 6, there is depicted a unit submodule interface 600 which may also comprise an aspect of the vehicle repair estimate generating module. In certain embodiments of the present invention, an estimate-generating user is directed to unit submodule interface 600 upon selecting the Next button 550 illustrated in FIG. 5. As is apparent from FIG. 6, within the unit submodule interface 600, an estimate-generating user may, if desired, select the Choose Unit button 610. If this button is selected, the user may select an existing unit, such as a commercial truck, from a unit database stored within the vehicle repair estimate generating module, in which unit data is stored. Alternatively, in certain embodiments, an estimate-generating user may enter such unit data directly onto unit submodule interface 600. In particular, in certain embodiments, the estimate-generating user may enter one or more of the following: (i) Unit Number, (ii) Year, (iii) Make, (iv) Model, (v) Style, (vi) vehicle identification number (VIN), (vii) License and State, (viii) Miles, (ix) Color/Paint Option, (x) Paint Code, (xi) Date of Loss, (xii) Transmission, and (xiii) Notes.

In certain embodiments, the un it submodule 600 interface may also include a custom configuration portion, wherein a user may create a custom parts list for non-supported vehicles or custom configurations. Referring to FIG. 6, there is seen a custom configuration portion 650, wherein the user may enter one or more of the following: (i) Custom Make, (ii) Custom Model, (iii) Custom Style, (iv) Box/Tank Make,. (v) Box/Tank #, (vi) Production Date, (vii) Engine/Horse Power, (viii) Custom Engine, and (ix) Custom Part List. From the Custom Part List drop down menu, the user may select parts relevant to the custom vehicle from a database of parts information. In certain embodiments, once the desired unit information is displayed on unit submodule interface 600, the estimate-generating user may select the Next button 680.

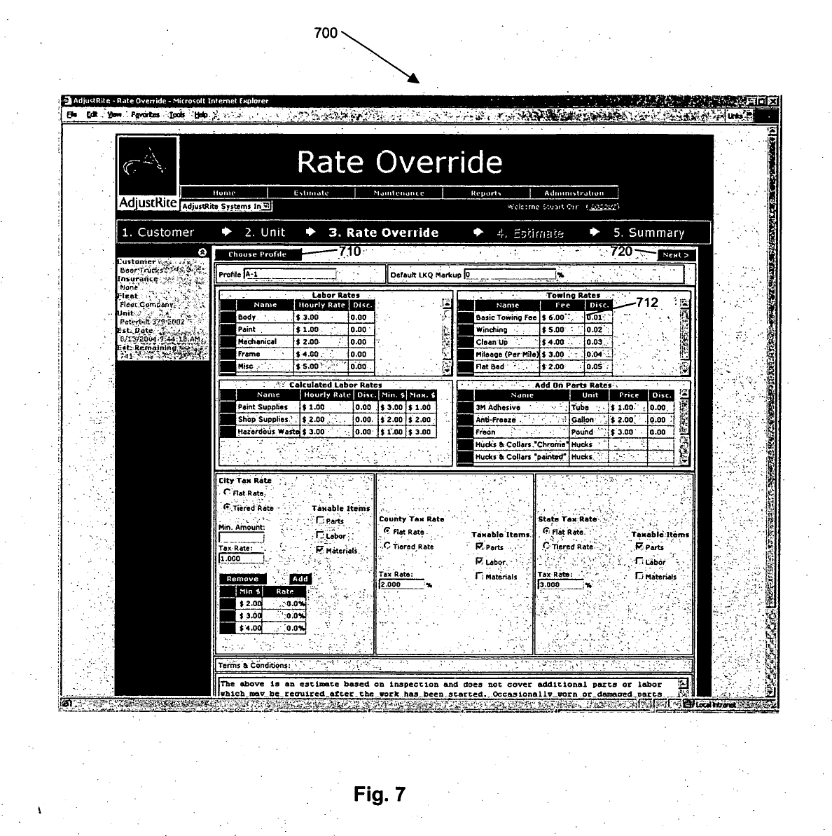

Now referring to FIG. 7, there is depicted a rate override submodule interface 700 which may also comprise an aspect of the estimate generating module in certain systems of the present invention. As used herein, the term “rate override submodule interface” refers to a section or component part of the computer-based system wherein an estimate-generating user may communicate with the estimate generating module to review and/or modify, for a particular estimate, stored data relevant to a repair facility, such as labor rates, towing rates, add on parts rates, and tax rates, among other things.

In certain embodiments of the present invention, an estimate-generating user may be directed to rate override submodule interface 700 upon selecting the Next button 680 illustrated in FIG. 6. As is apparent from FIG. 7, within the rate override submodule interface 700, an estimate-generating user may, if desired, select the Choose Profile button 710. If this button is selected, the user may select an existing profile from a profile database stored within the vehicle repair estimating module, in which profile data may be stored for a repair facility. Profile data that may be stored for a repair facility includes, without limitation, labor rates, such as body, paint, mechanical, frame, and miscellaneous labor rates; towing rates, such as a basic towing fee, a winching fee, a clean up fee, a mileage rate, and a flat bed fee; calculated labor rates, add on parts fees, and tax rates.

In the embodiment of the present invention illustrated in FIG. 7, upon selection of the Choose Profile button 710, rates are loaded from the profile database for a selected repair facility. These rates can be edited for a particular repair estimate within the rate override submodule interface 700 by selecting the appropriate field and then entering a modified rate. For example, to edit the basic towing fee to be charged for a particular repair estimate, the user may select field 712 and enter the desired value. Similar edits may be made for other fees, by selecting the appropriate field within FIG. 7. In certain embodiments, once the desired rate information is displayed on the rate override submodule interface 700, the estimate-generating user may select the Next button 720.

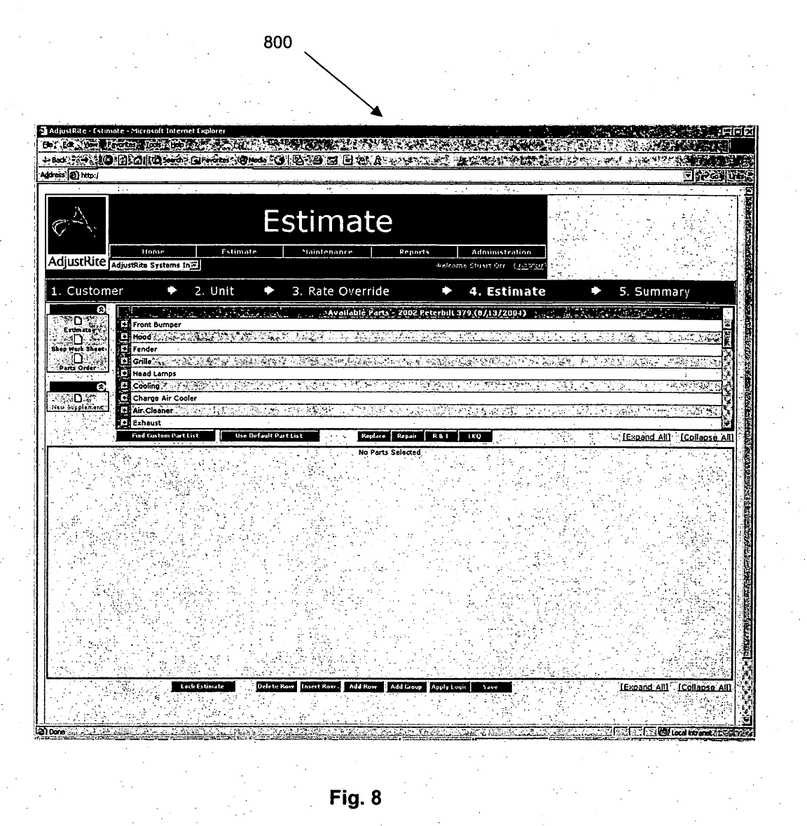

Now referring to FIG. 8, there is depicted an estimate submodule interface 800 which may also comprise an aspect of the vehicle repair estimate generating module in certain systems of the present invention. As used herein, the term “estimate submodule interface” refers to a section or component part of the computer-based system wherein an estimate-generating user may communicate with the estimate generating module to create a vehicle repair estimate.

In certain embodiments of the present invention, the estimate-generating user may be directed to the estimate submodule interface 800 upon selecting the Next button 720 illustrated in FIG. 7. As is apparent from FIG. 8, within the estimate submodule interface 800 there may be identified various part subgroups for a vehicle previously selected by the user. As is apparent, exemplary, but non-limiting part subgroups include, front bumper, hood, fender, grille, head lamps, cooling, charge air cooler, air cleaner, and exhaust.

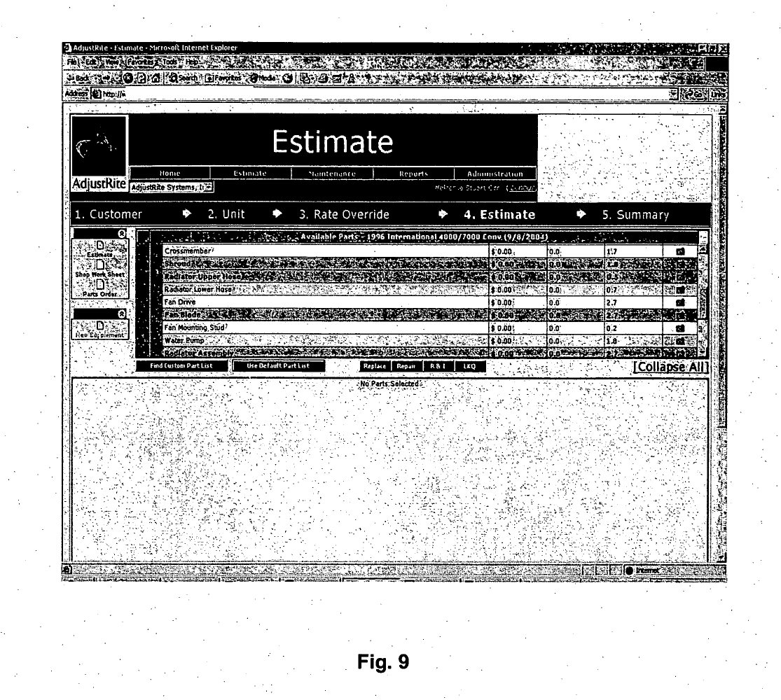

In the embodiment of the estimate submodule interface depicted by FIG. 8, an estimate-generating user may begin preparation of a repair estimate by selecting the appropriate part subgroup(s) that require repair and/or replacement. Specifically, as is shown in the example depicted by FIG. 9, the user has selected the parts subgroup entitled “Cooling” by selecting the “+” button 910 of FIG. 8 associated with the “Cooling” parts subgroup. This action has resulted in the illustration of various parts associated with the selected part subgroup, as shown in FIG. 9. As illustrated in the Figure, these parts include, in this example, Crossmember, Shroud, Radiator Upper Hose, Radiator Lower Hose, Fan Drive, Fan Blade, Fan Mounting Stud, Water Pump, and Radiator Assembly. The data associated with these parts is retrieved from the database 20 included within the systems of the present invention.

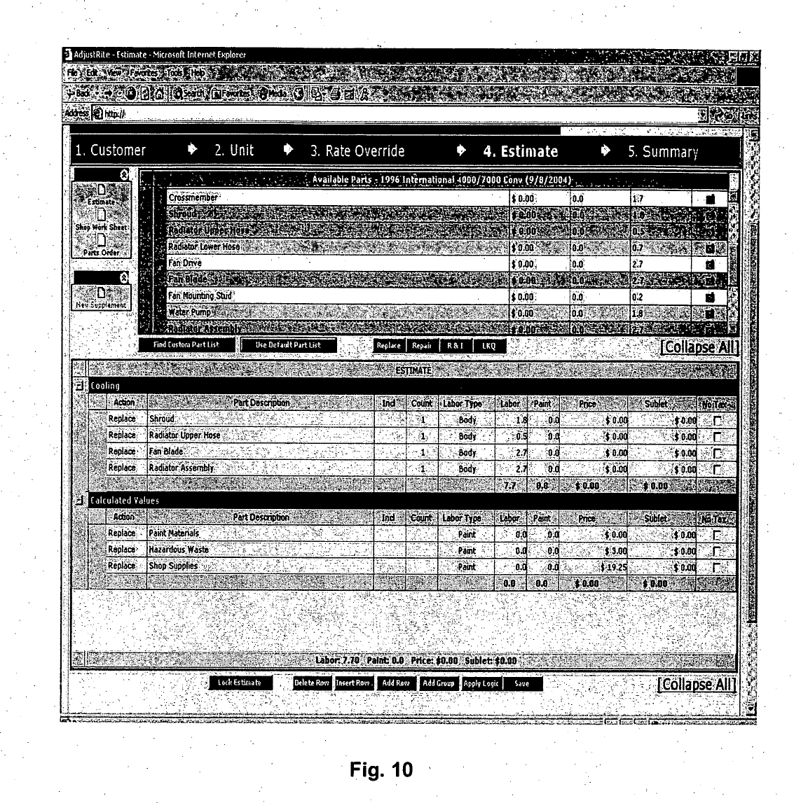

In certain embodiments of the present invention, estimate preparation is commenced when the estimate-generating user selects the parts, and/or entire part subgroups, that require action by selecting the appropriate field within the available parts list of FIG. 9. Now referring to FIG. 10, there is depicted an example wherein the user has determined that action is required with respect to certain parts within the “Cooling” part subgroup. In particular, the user has selected the parts entitled “Shroud,” “Radiator Upper Hose,” Fan Blade,” and “Radiator Assembly” by selecting the appropriate fields within the parts list of FIG. 10 and then selecting the desired action by selecting the “Replace” button. As a result, the system illustrates the various parts associated with the front bumper within the lower grid of FIG. 10, by retrieving the part data associated with the selected parts from the database 20.

As is apparent, there are several possible actions that may be required or desired with respect to a vehicle part. In the embodiment of the estimate submodule interface illustrated by FIG. 10, four possible actions are provided. These actions include: (1) Replace, which refers to the removal of an existing part and its replacement with a new part, (2) Repair, which refers to the removal and repair of an existing part, (3) R&I, which refers to the removal of a part to gain access to another part which requires repair or replacement and installation of the part after the repair or replacement is complete, and (4) LKQ, which refers to the replacement of an existing part with another part of like kind and quality, such as a used part. In the example illustrated by FIG. 10, the user selects the appropriate button for the selected part or part subgroup in order to record the required action. In addition, in the embodiments of the estimate submodule interface illustrated by FIG. 10, the user may edit values, such as the action, part description, labor times, price information, among others, by selecting the appropriate field and changing the illustrated value.

In certain embodiments of the present invention, once the user has identified all of the parts and/or part subgroups that require action, then the user may be prepared to generate an estimate. To do so, the user may, in certain embodiments of the present invention, select the Apply Logic button illustrated in FIG. 10. Upon selection of the Apply Logic button, the vehicle repair estimating module may, in certain embodiments, communicate with the database and access and retrieve the necessary data from the database to complete the estimate. As will be described in more detail below, the database may include parts information that adjusts the estimate, i.e., adjusts estimated material and/or labor times, based on the user-selected parts. This parts information, or logic, may be based on historical repair estimate data and may capture adjustments for adjacent parts, common forgotten add-on items, proper repair sequencing, and required associated operations for a particular repair, among other things.

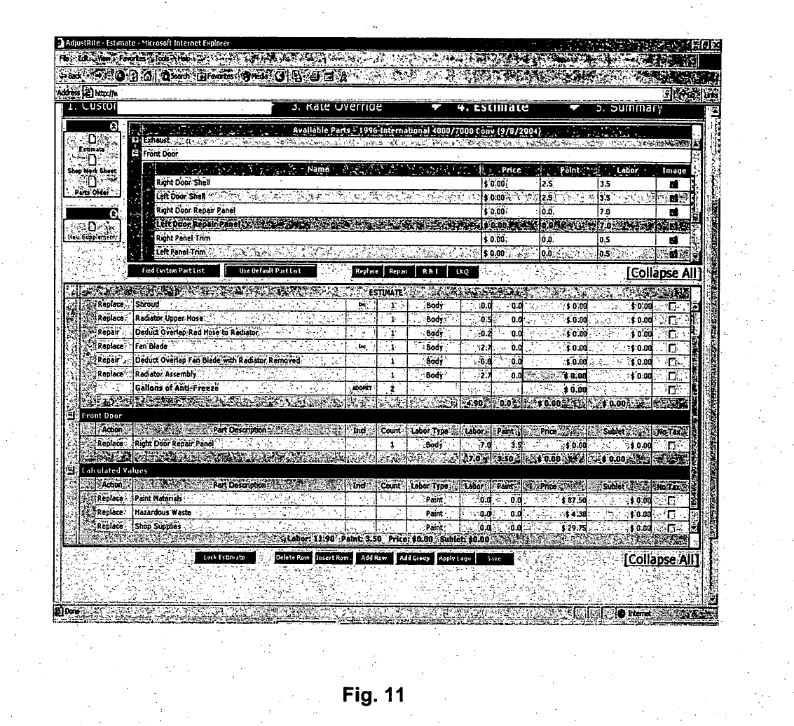

Referring now to FIG. 11, there is depicted an example wherein the vehicle repair estimating module 30 has retrieved the necessary data from the database 20 and incorporated that data into the repair estimate. As is apparent, the estimate has been revised, in this example, to deduct labor times for certain parts, as shown in the ESTIMATE grid of FIG. 11. In addition, the system has adjusted the estimate to capture certain forgotten add-on items, such as hazardous waste, anti-freeze, paint supplies, and shop supplies, which were not initially included within the estimate. Those adjustments are based on the information retrieved from the database. In this example, the repair has also been arranged in the proper repair sequencing.

At this point, the user may, in certain embodiments of the present invention, lock the estimate. To do so, the user may select the Lock Estimate button of FIG. 11. By locking the estimate, the user makes the estimate an official document that cannot be edited. In other words, if changes to the estimate need to be made, an estimate supplement is prepared. In the embodiment of the estimate submodule interface depicted in the Figures, including FIG. 11, the user may prepare an estimate supplement by selecting the “New Supplement” button.

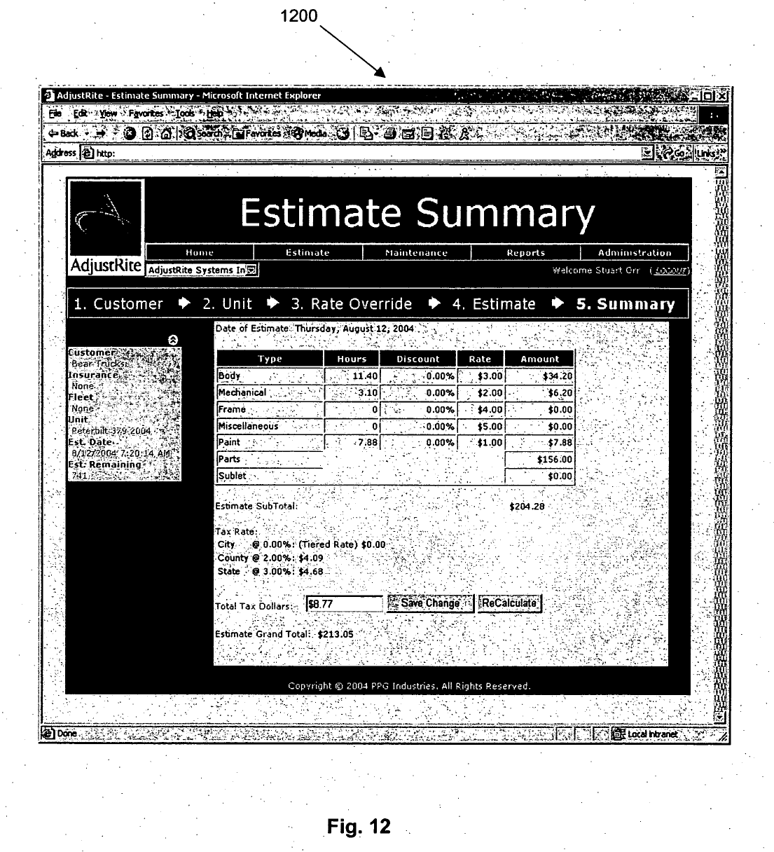

Now referring to FIG. 12, there is depicted an estimate summary submodule interface 1200 which may also comprise an aspect of the estimate generating module in certain systems of the present invention. As used herein, the term “estimate summary submodule interface” refers to a section or component part of the computer-based system wherein an estimate-generating user may communicate with the estimate generating module to review and/or modify a summary of a repair estimate.

In certain embodiments of the present invention, an estimate-generating user may be directed to estimate summary submodule interface 1200 upon selecting the Lock Estimate button within the estimate submodule illustrated in FIG. 11. As is apparent, the estimate summary submodule interface may, in certain embodiments of the present invention, illustrate a summary of the estimate by illustrating, for example, total labor times and rates, including body, mechanical, frame, paint, and miscellaneous labor, parts costs, and sublet costs, if any. The summary submodule may also illustrate tax costs and a total cost for the repair.

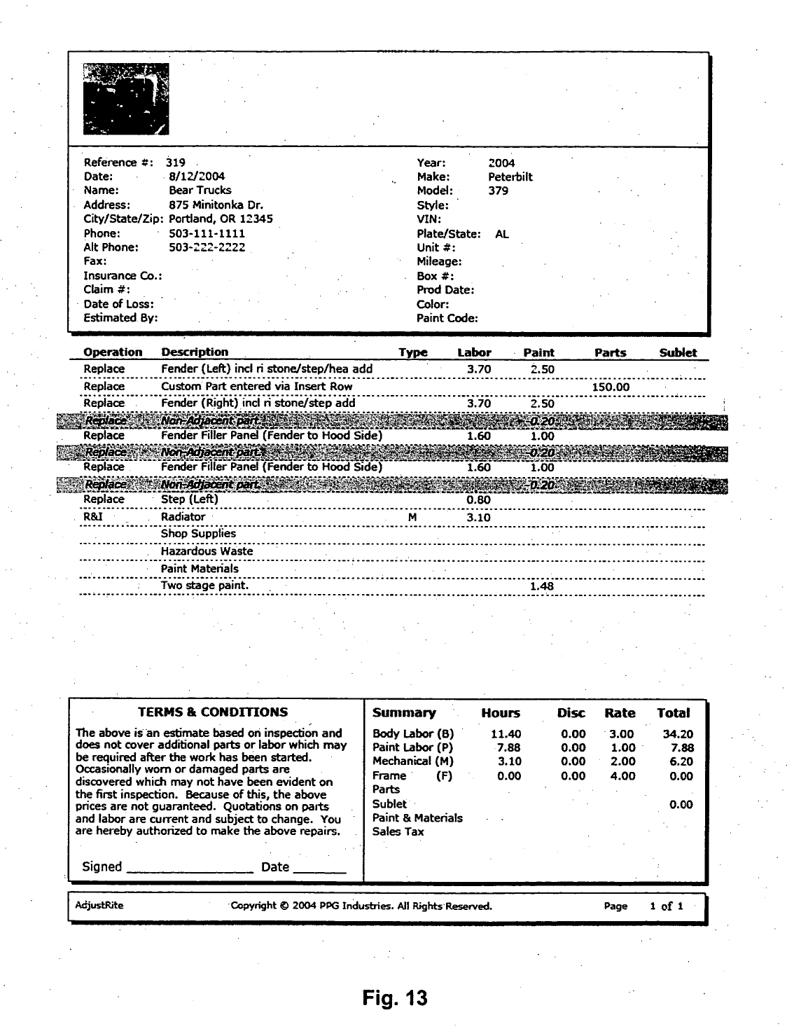

Referring now to FIG. 13, there is depicted an example of a repair estimate report corresponding to the estimate illustrated in FIG. 11. As is apparent, in this embodiment, the system has prepared a report suitable for submission to insurance companies and/or vehicle owners. If desired, this report may be delivered to an output device, such as a printer, fax machine, compact disc, and/or diskette, among other things.

As indicated earlier, the systems of the present invention also include at least one database modification module that is in communication with the database, wherein a database maintenance user can modify the database. As used herein, the term “database modification module” refers to a section or component part of the computer-based vehicle repair estimating system wherein vehicle data can be modified and those modifications communicated to the database. In the systems of the present invention, the database modification module is designed such that a database maintenance user who lacks computer programming skills, particularly high level computer programming skills, can modify the database. As used herein, the term “database maintenance user” refers to any individual or group of individuals who modify the database and who do not necessarily possess computer programming skills, such as high level computer programming skills. In the systems and methods of the present invention, the database maintenance user may be the same as or different from the estimate-generating user described above.

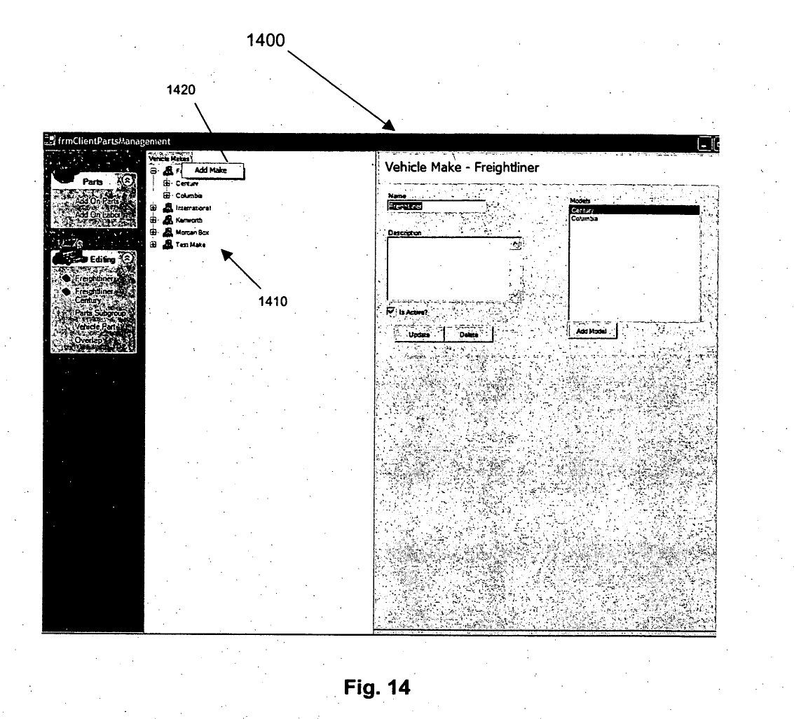

Certain embodiments of the database modification module of the systems of the present invention will now be described, beginning with reference to the database modification interface 1400 illustrated by FIG. 14. As used herein, the terms “modification interface” or “database modification interface” refer to a section or component part of the computer-based system wherein a database maintenance user can communicate with the database modification module in order to modify the database.

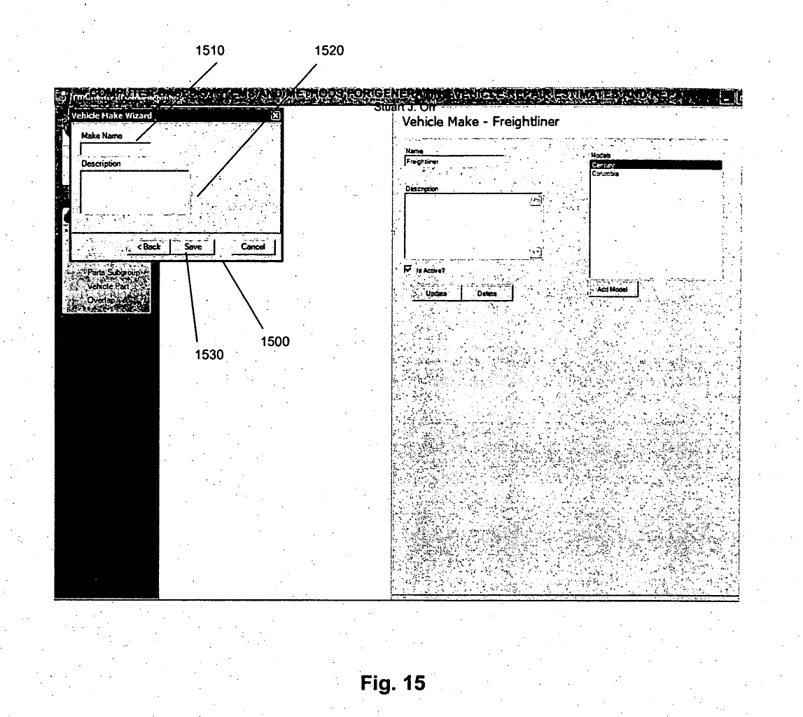

As is apparent, in certain embodiments of the present invention, the database modification module comprises commercial truck make data. In the embodiment illustrated in FIG. 14, the commercial truck make data is displayed in the form of a list of commercial truck makes 1410 existing within the database 20. To add a commercial truck make to the database 20, a database maintenance user can select the “Add Make” button 1420 on FIG. 14. In this embodiment, by selecting the “Add Make” button 1420, a Vehicle Make Wizard window 1500 appears as shown in FIG. 15. The database maintenance user can then enter a make name within field 1510 as well as a description of the make within field 1520. To save the make within the database, the user may select the Save button 1530. In certain embodiments, the selection of the Save button 1530 causes the database modification module 40 to communicate with the database 20 and modify the database 20 according to the change(s) made by the database maintenance user.

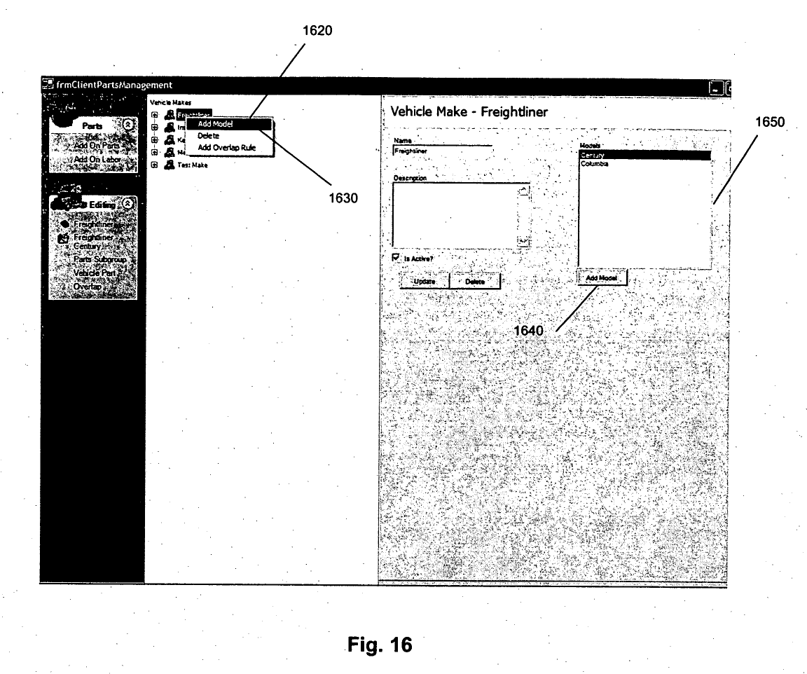

As previously indicated, in certain embodiments of the present invention, the database modification module comprises commercial truck model data. Referring now to FIG. 16, there is seen an example of a modification interface wherein a database maintenance user can modify commercial truck model data within the database by adding, removing, and/or changing the data. In particular, the user may modify commercial truck model data by selecting the appropriate truck model from a list of truck models. In this embodiment, three options, Add Model, Delete, and Add Overlap Rule, appear to the user as indicated by window 1620.

In the embodiment of the database modification interface illustrated in FIG. 16, a list of existing models corresponding to the selected truck make appears in field 1650. To add a model, the database maintenance user may select either Add Model option 1630 or 1640. Alternatively, the database maintenance user may, in certain embodiments, select the Delete option to remove a truck make from the database or Add Overlap Rule to create labor and/or parts overlap logic between parts subgroups for a particular vehicle model.

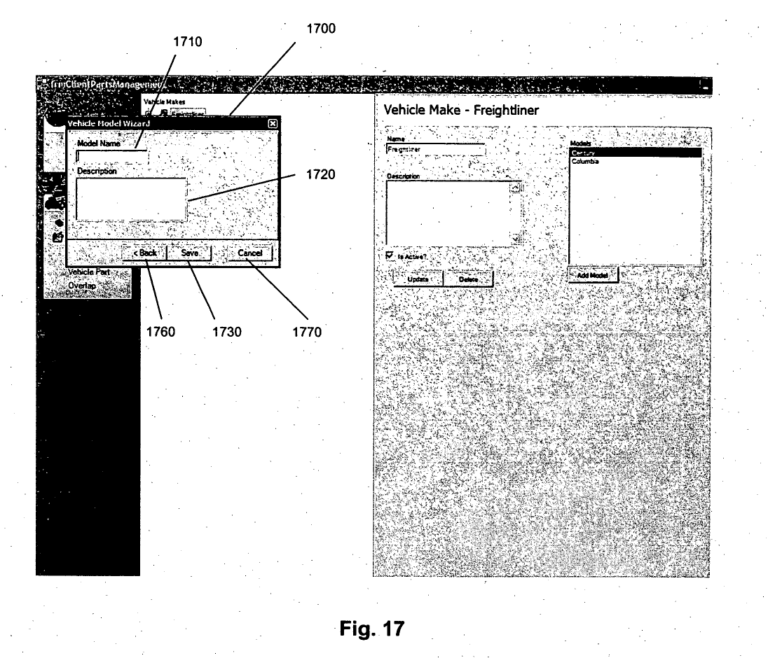

In the embodiment of the database modification interface of FIG. 16, the database maintenance user, by selecting Add Model 1630 or 1640, cause a Vehicle Model Wizard window 1700 to appear as shown in FIG. 17. In window 1700, the database maintenance user can enter a model name within field 1710 as well as a description of the model within field 1720. To save the make within the database, the database maintenance user may select the Save button 1730. In certain embodiments, the selection of the Save button 1730 causes the database modification module 40 to communicate with the database 20 and modify the database 20 according to the change(s) made by the database maintenance user. Alternatively, the database maintenance user may return to the previous screen by selecting the Back button 1760 or the user may cancel the transaction by selecting the Cancel button 1770.

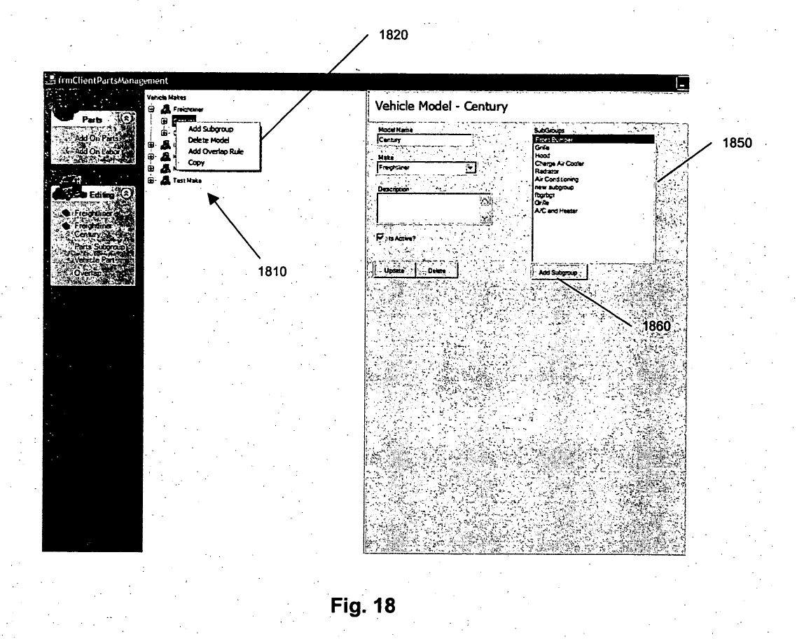

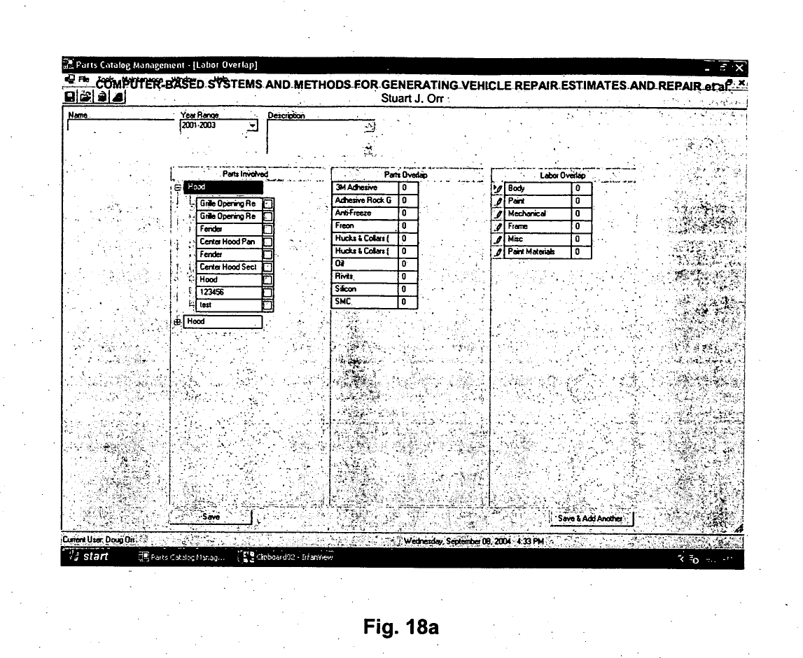

In certain embodiments of the present invention, the database modification module also comprises commercial truck part subgroup data. Referring now to FIG. 18 there is seen an example of a database modification interface wherein a database maintenance user can modify commercial truck part subgroup data within the database by adding, removing, and/or changing the data. In particular, in this embodiment, such a user may modify commercial truck part subgroup data by selecting the appropriate truck model and make from a list of truck models and makes 1810. In this embodiment, four options, Add Subgroup, Delete Model, Add Overlap Rule, and Copy appear to the user as indicated by window 1820. By selecting Delete Model, the user can delete the selected truck model from the database. By selecting Copy, the user can copy all of the data content within the selected model and insert it into a different model. The Copy selection can save the user time by allowing the user to copy entire groups of data and paste it into another truck model, rather than entering all new data. Be selecting Add Overlap Rule, the user can add parts and/or labor overlap logic between parts within a particular parts subgroup.

For example, should a database maintenance user select the Add Overlap Rule option, the user may, in certain embodiments, be directed to an Overlap interface of the type illustrated in FIG. 18a. Here, the user may select the parts involved in an overlap rule by selecting from a list of parts associated with a parts subgroup, such as the list shown in the “Parts Involved” field of FIG. 18a. Then, the user may enter the desired overlapping parts and labor overlap by selecting the appropriate fields in FIG. 18a.

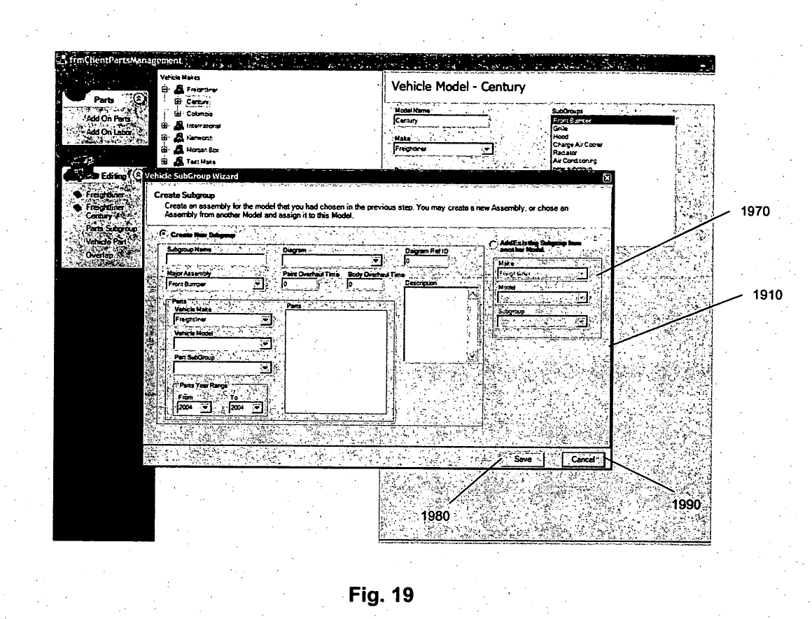

In the embodiment of the modification interface depicted in FIG. 18, a list of existing part subgroups corresponding to the selected truck model appears in field 1850. To add a part subgroup, the database maintenance user may select the Add Subgroup option from window 1820 or the user may select button 1860. In this embodiment, by selecting Add Subgroup 1830 or 1860, a Vehicle Subgroup Wizard window appears as shown in FIG. 19.

Referring now to FIG. 19, there is seen a Vehicle Subgroup Wizard window 1910 in which a database maintenance user can add commercial truck part subgroup data in accordance with certain embodiments of the present invention. In this embodiment, such a user can provide relevant data regarding the part subgroup by entering that data into the appropriate field. Such data may include, without limitation, Subgroup Name, Diagram, Major Assembly, Paint Overhaul Time, Body Overhaul Time, and Parts data. Alternatively, such a user may choose to add an existing part subgroup from another truck model by selecting the appropriate information from field 1970. To save the part subgroup within the database, the user may select the Save button 1980. In certain embodiments, the selection of the Save button 1980 causes the database modification module 40 to communicate with the database 20 and modify the database 20 according to the change(s) made by the database maintenance user. Alternatively, the user may cancel the transaction by selecting the Cancel button 1990.

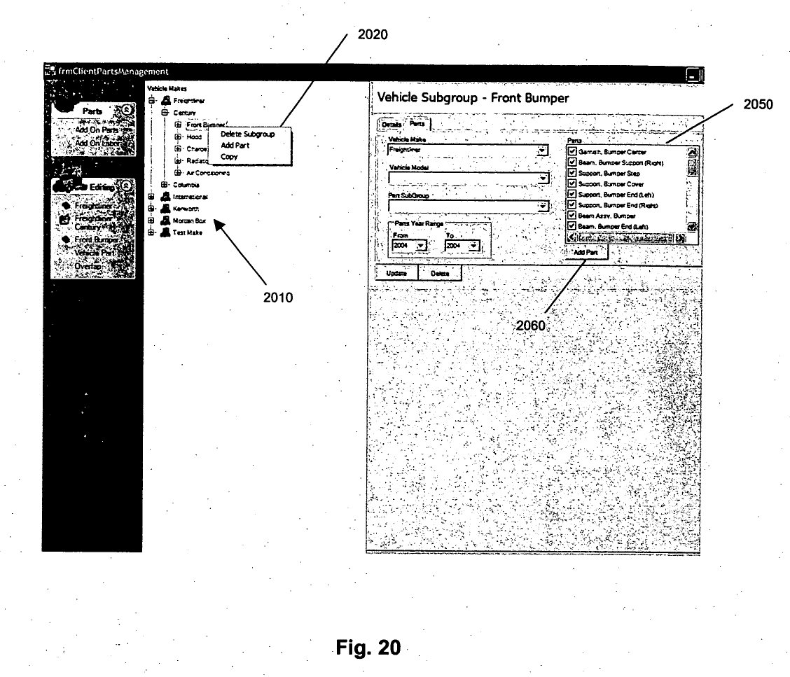

As previously indicated, in certain embodiments of the present, invention, the database modification module also comprises commercial truck part data. Referring now to FIG. 20, there is seen an example of a database modification interface wherein a database maintenance user can modify commercial truck part data within the database 20 by adding, removing, and/or changing the data. In particular, such a user may modify commercial truck part data by selecting the appropriate truck model, make, and part subgroup from a list of truck models, makes, and part subgroups 2010. In this embodiment, three options, Delete Subgroup, Add Part, and Copy appear to the user as indicated by window 2020. By selecting Delete Subgroup, the user can delete the selected subgroup from the database. By selecting Copy, the user can copy all of the data content within the selected model and insert it into a different model. The Copy selection can save a database maintenance user time by allowing the user to copy entire groups of data and paste it into another truck model, rather than entering all new data.

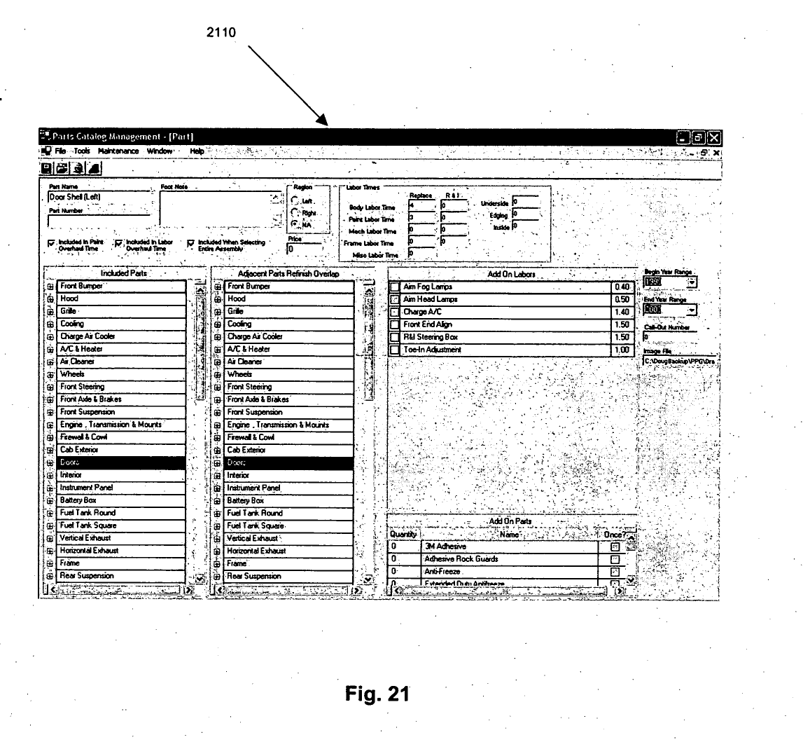

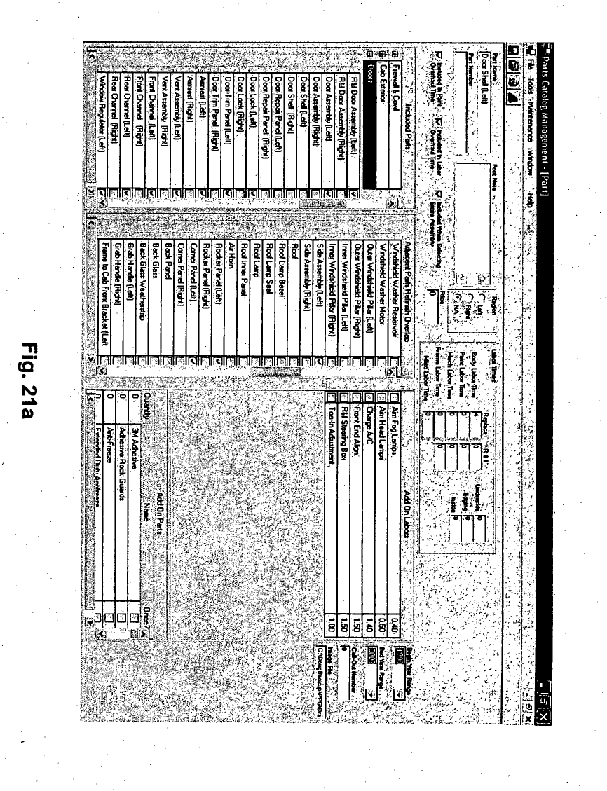

In the embodiment of the database modification interface depicted in FIG. 20, a list of existing parts corresponding to the selected truck model, make and part subgroup appears in field 2050. To add a part, the database maintenance user may select the Add Part option from window 2020 or from button 2060. In certain embodiments, by selecting Add Part 2030 or 2060, a Vehicle Part window appears as shown in FIG. 21.

Now referring to FIG. 21, there is seen a Vehicle Part window 2110 that, according to certain embodiments of the present invention, allows a database maintenance user to enter parts data and logic utilized to prepare a repair estimate of the type discussed earlier. In particular, in this embodiment, such a user can enter the following data for a particular part: Part Name, Part Number, Notes regarding the part, Part Year Range, whether the part should be included in Paint Overhaul Time, whether the part should be included in Labor Overhaul Time, Region, whether the part should be included when selecting an entire assembly, Price, Labor Times, Included Parts, Adjacent Parts Refinish Overlap, and Add-On Parts.

Still referring to FIG. 21, in this embodiment, when a user selects the “Included In Paint Overhaul Time” button, the system will calculate the paint labor time associated with the particular part (as provided in the appropriate field in FIG. 21) into the final value of a paint overhaul. However, if the total paint overhaul labor time for all of the parts reaches a given overhaul time, the paint labor time for a particular part will be eliminated in the estimate, and the total overhaul time will be used. A similar procedure is utilized for the “Included in Labor Overhaul Time” box, which refers to body labor, rather than paint labor. When a user selects the “Included When Selecting Entire Assembly” button, the system will include the selected part in an entire assembly if the estimate-generating user selects repair or replacement of the entire assembly, rather than a single part.

The “Included Parts” list of FIG. 21 includes a list of all parts in the database that are associated with a given vehicle model. Here, the database maintenance user may select the parts that are included for the labor time of the selected part. For example, as illustrated in FIG. 21a, the user has selected several “Included Parts” (R&I Door Assembly (Left), Door Assembly (Left), Door Lock (Left), Door Trim Panel (Left), Armrest (Left), Vent Assembly (Left), Front Channel (Left), Rear Channel (Left), and Window Regulator (Left)) to be associated with the labor time of the selected part (Door Shell (Left)). Thus, if an estimate-generating user indicates that a repair is needed for the parts entitled “Door Shell (Left)” and “Door Lock (Left) the system will communicate with the database 20 and eliminate labor time associated with the “Door Lock (Left)” in preparing the repair estimate.

The “Adjacent Parts Refinish Overlap” list of FIG. 21 include a list of parts from which the database maintenance user may select parts that are adjacent to the selected part, and which will not require additional refinish paint labor time. For example, as illustrated in FIG. 21a, the user has selected several “Adjacent Parts” (Side Assembly (Left), Rocker Panel (Left), and Corner Panel (Left)) that are adjacent to the selected part (Door Shell (Left)). Thus, when an estimate-generating user indicates that the parts entitled “Door Shell (Left)” and “Rocker Panel (Left)” need to be painted, the system will communicate with the database 20 and deduct a certain amount of paint labor time in the estimate for the Rocker Panel (Left) part.

The “Add-On Labor” checkbox menu of FIG. 21 allows a database maintenance user to select labor times required in an estimate every time that an estimate-generating user indicates that a repair is needed for the selected part. The “Add-On Parts” checkbox menu of FIG. 21 allows a database maintenance user to select parts required in an estimate every time that an estimate-generating user indicates that a repair is needed for the selected part. As a result, when an estimate-generating user indicates that a repair is need for the selected part, the system will communicate with the database 20 and added the selected Add-On Labor and Add-On Parts to the estimate.

In certain embodiments, when the user saves the entered information entered into the Vehicle Part window 2110 the database modification module 40 communicates with the database 20 and modifies the database 20 according to the information provided by the database maintenance user.

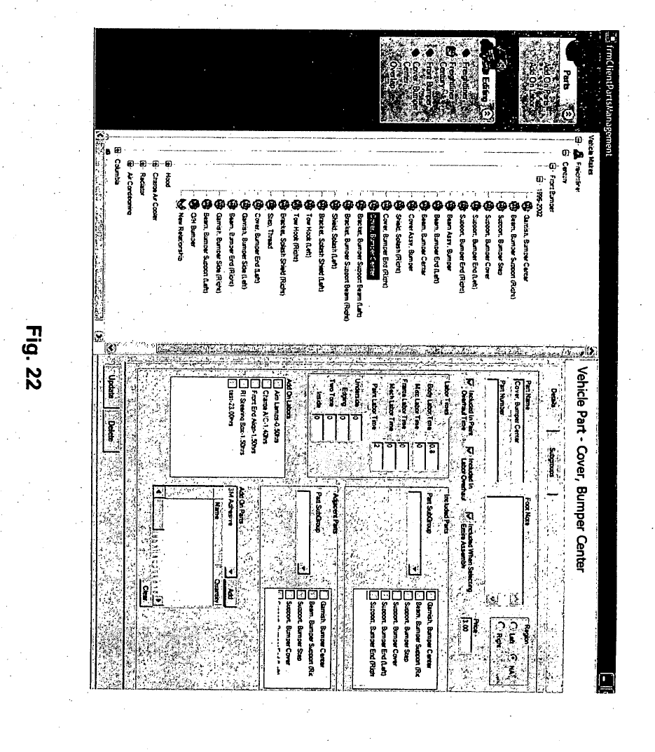

Referring now to FIG. 22, there is seen another view of a database modification module in accordance with certain embodiments of the present invention. As is apparent, in this example, a list of parts associated with the Freightliner truck make, Century truck model, Front Bumper part subgroup, years 1996-2002 is displayed. In this case, the user has selected the Cover, Bumper Center part and an editing window has appeared to the right of the parts list. From this window, the user can edit any of the data contained within the database for the selected part. Here, when the user selects the Update button, the database modification module 40 communicates with the database 20 and modifies the database 20 according to the information provided by the database maintenance user.

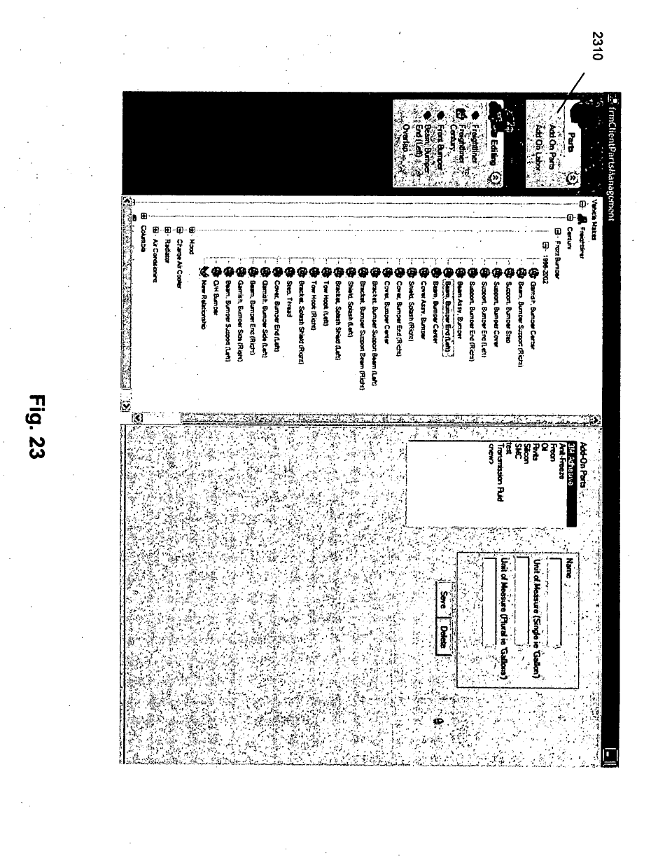

Referring now to FIG. 23, there is seen an Add-On Parts selection, which may be provided in accordance with certain embodiments of the present invention. In this example, a list of parts associated with the Freightliner truck make, Century truck model, Front Bumper part subgroup, years 1996-2002 is again displayed. From here, the user may simply select the Add On Parts button 2310, which causes a menu to display to the right of the parts list. This menu displays a list of Add-On Labor data that is associated with the selected part. The user can modify this data by selecting the appropriate fields within this menu.

The present invention is also directed to computer-based methods for generating commercial truck repair estimate reports. As should be apparent from the description herein, these methods of the present invention comprise the steps of: (a) receiving truck damage information from an estimate-generating user via a damage information input interface; (b) retrieving repair data from a database comprising at least one of commercial truck make data, commercial truck model data, commercial truck part subgroup data, or commercial truck part data; (c) illustrating selected repair data in an output interface; and (d) generating a truck repair estimate report based on the selected repair data. Such methods may also, in certain cases, comprise the step of delivering the contents of the report to an output device, such as any of the conventional output devices known to those skilled in the art, such as printers, fax machines, diskettes, compact discs and the like.

As should also be apparent from the foregoing description, the present invention is also directed to vehicle repair estimate reports, such as commercial truck estimate reports, prepared using the systems and/or methods of the present invention.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

We claim:

1. A computer-based vehicle repair estimating system comprising:
(a) at least one database comprising at least one of vehicle make data, vehicle model data, vehicle part subgroup data, or vehicle part data;
(b) at least one vehicle repair estimate generating module in communication with the database, wherein an estimate-generating user can create a vehicle repair estimate; and
(c) at least one database modification module in communication with the database, wherein a database maintenance user can modify the database.

2. The computer-based system of claim 1, wherein each of (a), (b) and (c) reside on a separate computer.

3. The computer-based system of claim 1, wherein the at least one vehicle repair estimate generating module and the at least one database modification module are in communication with the at least one database via the Internet.

4. The computer-based system of claim 1, wherein the vehicle make data comprises at least one of a make name, a make description, or an active status indicator.

5. The computer-based system of claim 1, wherein the vehicle model data comprises at least one of a model name, a related vehicle make, a model description, or an active status indicator.

6. The computer-based system of claim 1, wherein the vehicle part subgroup data comprises at least one of a subgroup name, a subgroup diagram, a related major assembly, a paint overhaul time, a body overhaul time, a subgroup description, a related vehicle make, or a related vehicle model.

7. The computer-based system of claim 1, wherein the vehicle part data comprises at least one of a part name, a part number, a part description, a part price, a region, an indication as to whether the part should be included in calculating paint overhaul time, an indication as to whether the part should be included in calculating labor overhaul time, an indication as to whether the part should be included when selecting an entire assembly, a labor time, included parts, add-on labors, adjacent parts, or add-on parts.

8. The computer-based system of claim 1, wherein the vehicle repair estimate generating module comprises a login interface.

9. The computer-based system of claim 1, wherein the vehicle repair estimate generating module comprises a home interface.

10. The computer-based system of claim 1, wherein the vehicle repair estimate generating module comprises a customer submodule interface.

11. The computer-based system of claim 10, wherein the estimate-generating user can enter customer information onto the customer submodule interface.

12. The computer-based system of claim 1, wherein the vehicle repair estimate generating module comprises a unit submodule interface.

13. The computer-based system of claim 12, wherein the estimate-generating user can enter unit information onto the unit submodule interface.

14. The computer-based system of claim 1, wherein the vehicle repair estimate generating module comprises a rate override submodule interface.

15. The computer-based system of claim 14, wherein the estimate-generating user can enter edits to repair facility data onto the rate override submodule interface.

16. The computer-based system of claim 1, wherein the vehicle repair estimate generating module comprises an estimate submodule.

17. The computer-based system of claim 16, wherein the estimate-generating user can select appropriate part subgroups that require repair and/or replacement via the estimate submodule.

18. The computer-based system of claim 1, wherein the vehicle repair estimate generating module comprises an estimate summary submodule interface.

19. The computer-based system of claim 18, wherein the estimate summary submodule interface illustrates total labor time and rates, parts costs, sublet costs, and tax costs associated with a vehicle repair estimate.

20. The computer-based system of claim 1, wherein the estimate-generating user and the database maintenance user are different.

21. The computer-based system of claim 1, wherein the database modification module comprises a database modification interface.

22. A vehicle repair estimate report prepared by the system of claim 1.

23. A computer-based commercial truck repair estimating system comprising:
(a) at least one database comprising at least one of commercial truck make data, commercial truck model data, commercial truck part subgroup data, or commercial truck part data;
(b) at least one commercial truck repair estimate generating module in communication with the database, wherein an estimate-generating user can create a commercial truck repair estimate; and
(c) at least one database modification module in communication with the database, wherein a database maintenance user can modify the database.

24. The computer-based system of claim 23, wherein each of (a), (b) and (c) reside on a separate computer.

25. The computer-based system of claim 23, wherein the at least one commercial truck repair estimate generating module and the at least one database modification module are in communication with the at least one database via the Internet.

26. The computer-based system of claim 23, wherein the commercial truck comprises a heavy truck.

27. The computer-based system of claim 23, wherein the commercial truck make data comprises at least one of a make name, a make description, or an active status indicator.

28. The computer-based system of claim 23, wherein the commercial truck model data comprises at least one of a model name, a related commercial truck make, a model description, or an active status indicator.

29. The computer-based system of claim 23, wherein the commercial truck part subgroup data comprises at least one of a subgroup name, a subgroup diagram, a related major assembly, a paint overhaul time, a body overhaul time, a subgroup description, a related commercial truck make, or a related commercial truck model.

30. The computer-based system of claim 23, wherein the commercial truck part data comprises at least one of a part name, a part number, a part description, a part price, a region, an indication as to whether the part should be included in calculating paint overhaul time, an indication as to whether the part should be included in calculating labor overhaul time, an indication as to whether the part should be included when selecting an entire assembly, a labor time, included parts, add-on labors, adjacent parts, or add-on parts.

31. The computer-based system of claim 23, wherein the commercial truck repair estimate-generating module comprises a login interface.

32. The computer-based system of claim 23, wherein the commercial truck repair estimate generating module comprises a home interface.

33. The computer-based system of claim 23, wherein the commercial truck repair estimate generating module comprises a customer submodule interface.

34. The computer-based system of claim 33, wherein the estimate-generating user can enter customer information onto the customer submodule interface.

35. The computer-based system of claim 23, wherein the commercial truck repair estimate generating module comprises a unit submodule interface.

36. The computer-based system of claim 35, wherein the estimate-generating user can enter unit information onto the unit submodule interface.

37. The computer-based system of claim 23, wherein the commercial truck repair estimate generating module comprises a rate override submodule interface.

38. The computer-based system of claim 37, wherein the estimate-generating user can enter edits to repair facility data onto the rate override submodule interface.

39. The computer-based system of claim 23, wherein the commercial truck repair estimate generating module comprises an estimate submodule.

40. The computer-based system of claim 39, wherein the estimate-generating user can select appropriate part subgroups that require repair and/or replacement via the estimate-submodule.

41. The computer-based system of claim 23, wherein the commercial truck repair estimate generating module comprises an estimate summary submodule interface.

42. The computer-based system of claim 41, wherein the estimate summary submodule interface illustrates total labor time and rates, parts costs, sublet costs, and tax costs associated with a commercial truck repair estimate.

43. The computer-based system of claim 23, wherein the estimate-generating user and the database maintenance user are different.

44. The computer-based system of claim 23, wherein the database modification module comprises a database modification interface.

45. A commercial truck repair estimate report prepared by the system of claim 23.

46. A computer-based method for generating commercial truck repair estimates comprising:
(a) receiving truck damage information from an estimate-generating user via a damage information input interface;
(b) retrieving repair data from a database comprising at least one of commercial truck make data, commercial truck model data, commercial truck part subgroup data, or commercial truck part data;
(c) illustrating selected repair data in an output interface; and
(d) generating a truck repair estimate report based on the selected repair data.

47. The computer-based estimate of claim 46, further comprising delivering the truck repair estimate report to an output device.
